(19) United States
(12) Patent Application Publication
(10) Pub. No.: US 2008/0162348 A1
(43) Pub. Date: Jul. 3, 2008

(54) Electronic-Purse Transaction Method and System

(75) Inventors: Eng Sia Lee, Penang (MY); Heng Ho Peter Yeow, Selangor Darul Ehsan (MY); Jin Feei Jeffrey Loh, Selangor Darul Ehsan (MY)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: MOBILE MONEY INTERNATIONAL SDN BHD, Selangor (MY)

(21) Appl. No.: 11/718,630

(22) PCT Filed: Sep. 8, 2005
(86) PCT No.: PCT/SG05/00308

§ 371 Date: May 4, 2007

(30) Foreign Application Priority Data
Nov. 5, 2004 (MY) PI 200444611

(51) Int. Cl. G06Q 20/00

(52) U.S. Cl. 705/44; 705/39

(57) ABSTRACT

Users (302,403,406) of a bank (332,324)put funds into user credit account (112,114,116,118) from which the funds can be transferred to a consolidated e-purse ban account (120) within the bank (332,324). The consolidated e-pures bank account (120) i mirrored in a e-purse database (204), but with fund allocated to different e-purese (212,214,216,218,226,228) the total of all funds in the different c-purse (212,214,216,218,226,228) beeing equal to the funds in the consolidated e-purse ban account. When a first user (302) wishes to make a purchase from a second user (304), h sends an SMS message (352) to a mobile telephone payment gateway (320) indicating th second user (304) and an amount. The indicated amount of funds is removed from the fir users's e-purese (212). When the purchase is confirmed, the funds are transferred into th second user's e-purse (214), less transaction charges. These funds are immediately availabl to the second user (304).

### FIELD OF THE INVENTION

The present invention relates to an electronic-purse (e-purse) transaction system and method therefor, for instance for making payments, in particular by mobile telephone.

### BACKGROUND OF THE INVENTION

A new mode of payment that has emerged recently is electronic payment, or e-payment, for instance via the Internet or a mobile telephone. E-payment is quick, without reliance on tools such as swipe cards, card readers and chequebooks. Generally, the development of e-transactions via telephones is directed towards the activation of transactions by SMS. However, the infrastructure and technical expertise required for telephone-based e-transactions are beyond the traditional set-up and capabilities of banks. Further, in general, banks cannot easily upgrade themselves to state-of-the-art telecommunication and customer-relation management (CRM) technologies. Therefore, it is not uncommon for a bank to employ an external telecommunication company to set-up its e-payment system. Even then, however, e-payment system management and administration usually remain within the bank. This is a disadvantage as banks are necessarily bureaucratic and require time for processing and approving e-payments.

Specifically, in an electronic transaction on credit, the payer's credit is immediately deducted while the merchant receives money much later, causing an undesirable lag of time between payment and receipt. A merchant, though having closed an electronic sale, has to wait for a period of time before he receives the money he earned and can use the money for his own purchases. This inconveniences the use of electronic transaction and is unwelcome by some merchants. For example, taxis in Singapore accept credit card payment but the taxi drivers are unwilling to do so, as cash from the credit card payment cannot be realised immediately. The reason of wanting to receive cash immediately is so that the taxi drivers can use the payment money at once, for their own purchases.

Furthermore, e-payment has slow momentum. Credit issued can only be used once and in a single transaction. Money on credit is used in one single purchase, after which it has to be processed by the bank or credit facility. The merchant who receives the payment cannot transfer the credit to another person in a transaction of his own but must first receive the actual payment in order to use the money. In other words, the credit paid out by a payee cannot be re-cycled immediately by the merchant in a subsequent purchase of the merchant's initiation. As a result, despite assistance from technological companies, banks fall short of the objective of electronic transactions, which is to ease up and speed up transactions, especially in the merchants' favour.

Although banks and other financial institutions leverage on technological advances in managing lending, they are nonetheless not technological companies. As a result, introduction of the latest technologies in such institutions is often delayed. Furthermore, financial institutions are unwilling to risk mess-ups and prefer to remain in the domain of ‘safe’ technologies, which are established and are well understood by other banks, clients and monetary authorities. Therefore, there is inertia in financial institutions to adopt cutting-edge technology.

### SUMMARY

According to one aspect of the present invention, there is provided a method of making transactions between e-purses. The e-purses represent funds belonging to different users, with the total of the funds represented by the e-purses being mirrored in a consolidated bank account in a bank. The method comprises: instructing a transaction comprising a transfer of funds from a first e-purse to a second e-purse by an electronic message; removing funds from the first e-purse as a result of the electronic message; and transferring funds into the second e-purse as a result of the electronic message.

According to a second aspect of the present invention, there is provided a method of obtaining tokens which are of a monetary value or for making a specific purchase. The method comprises: instructing a transaction comprising a request, by an electronic message, for a token; removing funds from a first e-purse as a result of the electronic message; and transmitting the token electronically to a first user with whom the first e-purse is associated.

According to a third aspect of the present invention, there is provided a method of withdrawing funds from a first e-purse from an e-purse database comprising a plurality of e-purses represent funds belonging to different users. The total of the funds represented by the e-purses is mirrored in a consolidated bank account in a bank. The method comprises: instructing a transaction comprising a withdrawal of funds from the first e-purse by an electronic message; removing funds from the first e-purse as a result of the electronic message; and removing funds from the consolidated bank account into a bank account associated with the user of the first e-purse as a result of the electronic message. The amount of funds removed from the consolidated bank account is deleted from the funds in the e-purse database.

According to a fourth aspect of the present invention, there is provided an e-purse system for receiving transaction instructions sent by an electronic message, to transfer funds between users of the system. The system comprises: an e-purse database and a bank database. The e-purse database comprises a plurality of e-purses represent funds belonging to different users. The bank database comprises a consolidated bank account. The transfer of funds between users of the system comprise transfers of funds between e-purses. The totals of funds represented by the e-purses are mirrored in the consolidated bank account.

The system of the fourth aspect is operable according to the methods of one or more of the first to third aspects.

According to an embodiment, users of a bank put funds into user credit accounts, from which the funds can be transferred to a consolidated e-purse bank account within the bank. The consolidated e-purse bank account is mirrored in an e-purse database but with funds allocated to different e-purses, the total of all the funds in the different e-purses being equal to the funds in the consolidated e-purse bank account. When a first user wishes to make a purchase from a second user, he sends an SMS message to a mobile telephone payment gateway indicating the second user and an amount. The indicated amount of funds is removed from the first user's e-purse. When the purchase is confirmed, the funds are transferred into the second user's e-purse, less transaction charges. These funds are immediately available to the second user.

A possible advantage provided by the present invention is e-payment with the flexibility and speed of the flow of hard cash, as well as the accountability, security and traceability of electronic money.

The invention can be used to free banks from the inertia to adopt new technologies, particularly, where electronic transactions, are concerned. Embodiments are also able to provide an e-purse system wherein (electronic) money movement is fully manageable by a technical body, which has, at its disposal, state-of-the-art technology, without the e-purse system compromising the security, accountability and responsibility of the bank for which it is implemented. Such e-purse systems can also provide for unrealised funds paid on credit to a merchant to be useable immediately by a merchant for transactions of his own, such that funds issued by a bank or credit facility remain in circulation for multiple transactions.

Without necessarily being limited to use with an e-purse system, and otherwise being useful, according to a fifth aspect of the present invention, there is provided a method of transmitting confidential information to a predetermined user. The method comprises: associating confidential information with other contact details agreed with the predetermined user to generate a dummy contact; and sending the dummy contact to an electronic device associated with the user.

### BRIEF DESCRIPTION OF THE DRAWINGS

Embodiments of the invention will now be described, by way of non-limitative example, with reference to the accompanying drawings, in which:

FIG. 1 illustrates a schematic view of the basic structure of an e-purse system of one embodiment;

FIG. 2 is a flowchart relating to various steps -that occur when one user makes a purchase from another user;

FIG. 3 is a flowchart relating to various steps that occur when an e-purse withdrawal occurs; and

FIG. 4 is a schematic view of an overall transaction system including the e-purse system of FIG. 1.

### DETAILED DESCRIPTION

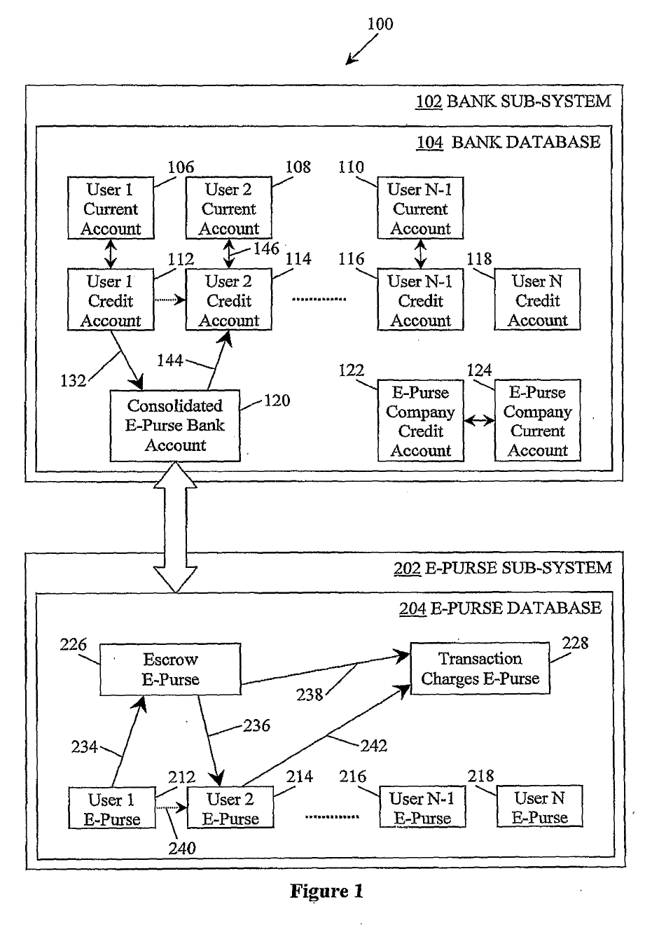

FIG. 1 illustrates a schematic view of the basic structure of an e-purse system 100 of one embodiment. The e-purse system 100 has two sides: a bank sub-system 102 including a bank database 104 and an e-purse sub-system 202 including an e-purse database 204.

The bank database 104 has typical banking facilities, including a number of user savings and current accounts, exemplified in FIG. 1 by way of a user 1 current account 106, a user 2 current account 108 and a user N-1 current account 110. The bank database 102 also includes a number of user credit accounts, exemplified in FIG. 1 by way of a user 1 credit account 112, a user 2 credit account 114, a user N-1 credit account 116 and a user N credit account 118. The user credit accounts contain what may be described as electronic money, but which is generally referred to herein as funds. The user credit accounts may be associated with the respective user current and/or savings accounts, but need not necessarily be. In FIG. 1, the user N credit account 118 is not associated with any other bank account.

Additionally, the bank database 104 includes a consolidated e-purse bank account 120. There is also an e-purse sub-system credit account 122 and associated e-purse sub-system current account 124, for the company running the e-purse system to add money to and withdraw money from the consolidated e-purse bank account 120. These are operable in similar ways to the user credit and current accounts which operations are described below.

The e-purse database 204 has a number of user e-purses 212, 214, 216, 218, one for each user credit account 112, 114, 116, 118 in the bank database 104. Thus, there is a user 1 e-purse 212, a user 2 e-purse 214, a user N-1 e-purse 216 and a user N e-purse 218. Additionally, the e-purse database 204 contains an escrow e-purse 226 and a transaction charges e-purse 228. Within the c-purse database 204, the user N e-purse 118 is treated no differently from the other e-purses, even though, in the bank sub-system 102, the user N has no bank account other than the user N credit account 118.

All the money inside the various e-purses actually resides inside the consolidated e-purse bank account 120 residing in the bank. Thus, at any one time, the total sum of funds inside the e-purse database 204 is equal to the funds held inside the consolidated e-purse bank account 120. During movement of funds from e-purse to e-purse, none of the e-purse funds leave the bank or the consolidated e-purse bank account 120. However, their allocation to different e-purses is determined outside the bank, in the e-purse database 204. The e-purse accounts contain e-money or funds which represent money or money on credit which e-purse users can use to pay each other for goods or services. The term “funds” is used, instead of the terms “money” or “credit” alone, to describe that which is held in the e-purses, as the e-purse database 204 does not actually hold money in any real currency but only a representation of the money.

Operations relating to various aspects of the use of the bank database 104 and the e-purse database 204 are described further, some with reference to various Figures.

The simplest way for a user to put funds into the respective user e-purse is to instruct a transfer from the user credit account at the bank database 104 into the user e-purse. When this happens, the funds are deducted from the user credit account and transferred to the consolidated e-purse bank account 120. Within the e-purse database 204, the new funds in the consolidated e-purse bank account 120 are allocated to the relevant e-purse. In order to put the funds into the user credit account at the bank, the user may transfer money from one of his other accounts, e.g. his current of savings account. Alternatively, he may pay the money directly into the credit account, e.g. by cash, cheque, mobile telephone payment outlets, etc. (e.g. as user N would have to do). As another possibility, the user credit accounts may be run as credit card accounts, money only being payable into them in arrears.

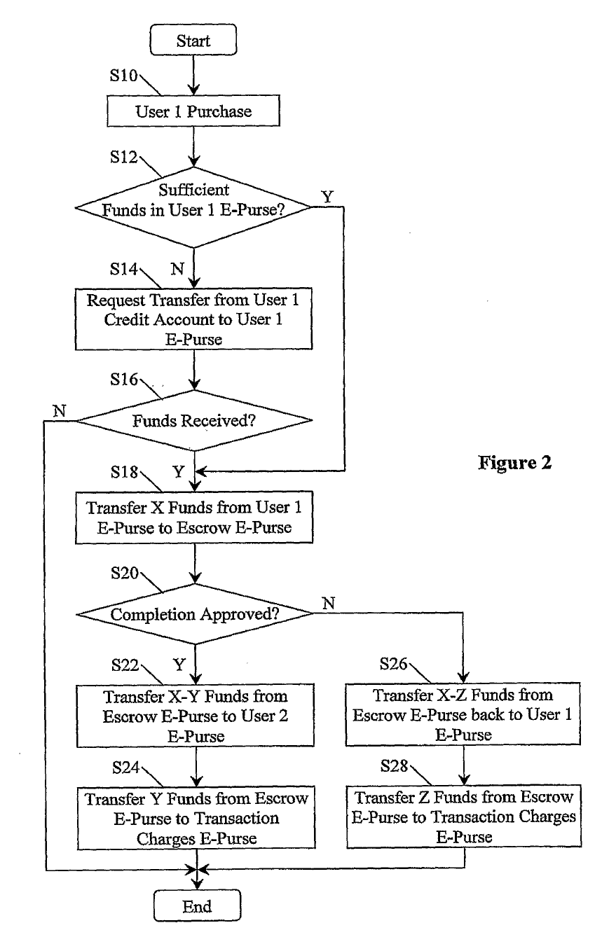

FIG. 2 is a flowchart relating to various steps that occur when user 1 makes a purchase from user 2 (or otherwise transfers funds to user 2). This requires funds to be transferred from the user 1 e-purse 212 are transferred to the user 2 e-purse 214. In the preferred embodiment, there is no direct transfer from the user 1 e-purse 212 to the user 2 e-purse 214. Instead, the system 100 uses the escrow e-purse 226, in between.

When a purchase for amount X by user 1 is instructed (step S10), the system determines if there are sufficient funds for the transfer in the user 1 e-purse 212 (step S12), that is whether the user 1 e-purse 212 contains at least X. If there are not enough funds for this transfer, the system issues a request to the bank for funds equal to the difference between amount X and the amount that is actually in the user 1 e-purse 212 to be transferred from the user 1 credit account 112 into the user 1 e-purse 212 (step S14). The system determines if the relevant funds are received in the consolidated e-purse bank account 120 (arrow 132 in FIG. 1), where they are transferred into the user 1 e-purse 212 (step S16). If the relevant funds are not received, for example because the user 1 credit account 112 has insufficient funds in it, the user 1 credit account 112 would thereby be taken over its credit or overdraft limit (that is it would meet its allowance limit), or because there is a block against transfers being made from the user 1 credit account 112 into the consolidated e-purse bank account 120 without express instructions from user 1, the process ends without any transfer of funds occurring (and user 1 is notified accordingly).

If the determination at step S12 is that the user 1 e-purse 212 contains sufficient funds for the transfer or if the determination at step S16 is that the relevant funds are received from the bank, then a transfer is made of amount X from the user 1 e-purse 212 to the escrow e-purse 226 (step S18) (arrow 234 in FIG. 1). A determination is made of whether completion of the transaction is approved (e.g. through user 1 confirming receipt and satisfaction with the goods/service) (step S20). The funds X remain in the escrow e-purse 226 until then.

If the completion is approved at step S20, an amount of X-Y is transferred from the escrow e-purse 226 to the user 2 e-purse 214 (step S22) (arrow 236 in FIG. 1) and the amount of the difference Y is transferred from the escrow e-purse 226 to the transaction charges e-purse 228 (step S24) (arrow 238 in FIG. 1). The amount Y represents transaction charges (although in other embodiments it may represent a commission or other service charges). The amount Y may typically be a percentage of the amount X, for instance 0.1%, although it may be a fixed amount. The effect of the overall process is a transfer of funds from the user 1 e-purse 212 to the user 2 e-purse 214, as indicated by the dotted arrow 240 in FIG. 1.

If the completion is not approved at step S20, an amount of X-Z is transferred from the escrow e-purse 226 back to the user 1 e-purse 212, from whence the amount X had come, (step S26) and the amount of the difference Z is transferred from the escrow e-purse 226 to the transaction charges e-purse 228 (step S28). The amount Z represents transaction charges (although in other embodiments it may represent a commission or other service charges), even though the purchase is rejected. This is to discourage frivolous rejections of a purchase. The amount Z may typically be a percentage of the amount X, for instance 0.1% (or usually higher than the amount Y), although it may be a fixed amount. In alternative embodiments, an amount may also be passed on to the user 2 e-purse, deducted from the amount X held in the escrow e-purse 226 to cover costs borne by user 2, e.g. postage.

Once the funds are transferred into the user 2 e-purse 214, they are available immediately for use by the user of the second e-purse (to transfer to another user or to withdraw).

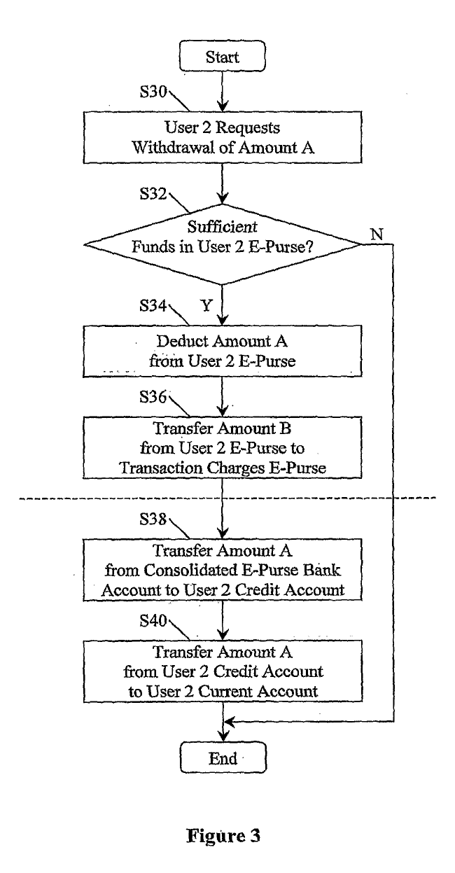

A user may withdraw funds from his e-purse and transfer them to his credit account in the bank and from there into his current or savings account or otherwise take them out as money. For example, user 2, having received funds from user 1, may decide to encash some of the funds in the user 2 e-purse 214 into the user 2 current account 108. FIG. 3 is a flowchart relating to various steps that occur when such a withdrawal occurs.

User 2 requests withdrawal of an amount A from the user 2 e-purse 214 (step S30). A determination is made of whether there are sufficient funds for the transfer in the user 2 e-purse 214 (step S32), that is whether the user 2 e-purse 214 contains at least amount A plus a further amount B mentioned further below. If there are not sufficient funds in the user 2 e-purse 214 at step S32, the process ends (and user 2 is notified accordingly).

If there are sufficient funds in the user 2 e-purse 214 at step S32, the amount A is deducted from the user 2 e-purse 214 (step S34) and a further amount B is transferred from the user 2 e-purse 214 to transaction charges e-purse 228 (step S36) (arrow 242 in FIG. 1). The amount B represents transaction charges (although in other embodiments it may represent a commission or other service charges). The amount B may typically be a percentage of the amount A, for instance 0.1%, although it may be a fixed amount.

The above steps in the process of withdrawing funds from an e-purse take place within the e-purse database 204. In the bank database 104, the amount A is transferred from the consolidated e-purse bank account 120 to the user 2 credit account 114 (step S38) (arrow 144 in FIG. 1). In this instance, as the user 2 instructs encashing of the funds A, the amount A is further transferred from the user 2 credit account 114 to the user 2 current account 108 (step S40) (arrow 146 in FIG. 1).

In the above-described embodiment, transfers into and out of the user e-purses are via the user credit accounts. In alternative embodiments, instead of a credit account, a user can use a current or savings account or some other account directly.

In the above embodiment, funds being transferred between users are held in escrow until the transaction is approved. In alternative embodiments, there is a direct transfer of funds from the user 1 e-purse 212 to the user 2 e-purse 214. This may be accompanied by a further transfer of a transaction charge, either direct from the user 1 e-purse 212 to the transaction charges e-purse 228 and/or direct from the user 2 e-purse 214 to the transaction charges e-purse 228 (depending on default settings or any agreement on this point). In a farther embodiment, some transfers may be direct and others via escrow as indicated by the originator of the funds (usually a payer) and/or the recipient of the funds (usually a payee). For example, for over the counter sales, the transfer can be direct, without passing through the escrow e-purse 226, whilst remote sales (e.g. over the Internet or via telephone) can use the escrow e-purse 226. Where the escrow e-purse 226 is used, any disagreement over whether the funds should be released to the seller can be decided by the e-purse sub-system 202 or by a third party arbitrator (which may include the bank). Where the transfer is to be direct, the removal of funds from the user 1 e-purse 212 and the transferral of funds into the second e-purse 214 are near immediate upon receipt of the instruction of the transfer. It is only near immediate as there may checks to confirm the identity of the user 1 and a need to confirm that the user 1 e-purse 212 contains sufficient funds. There may also be other minor delays. The actual fund transfer should take less than about 3 seconds. However, the transmission of SMS messages is less predictable and generally takes longer. As a result, the overall transfer may take one or two minutes to complete.

Transaction charges are typically based on each transaction. Alternatively, there may be no specific transaction charge associated with any transaction. Instead, the body managing the system may take funds through other mechanisms, e.g. an annual or monthly fee, either at a fixed level or based on the volume of payments and/or receipts from a previous time period, or when users put funds into the e-purse and/or when they take them out, or only when the payers or payees e-purse level reduces below a certain amount.

An advantage of the consolidated bank account which is used in the above-described embodiments, is that no funds are represented in the e-purse database 104 or made available to a user that are not backed up with real money. Thus, even if the company running the e-purse system were to collapse, the money belonging to the various users would still be present in the bank account and could be returned to them, thus reducing the risk to users. Moreover, mirroring and reconciliation of funds can be conducted in real time; every single cent or penny inside the e-purse database is backed up by real value inside the consolidated bank account. There can be checks and measures or mechanisms in place to enforce this.

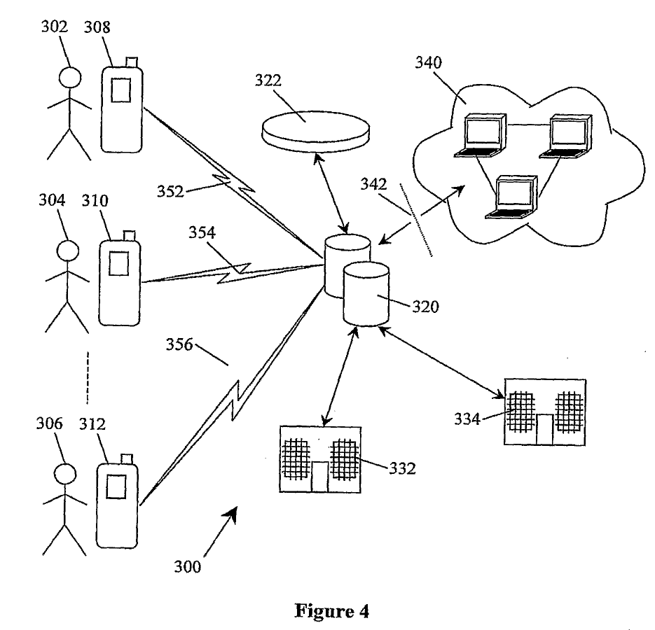

FIG. 4 is a schematic view of the overall transaction system 300 including the e-purse system 100 of FIG. 1.

The system has a number of users: user 1 302, user 2 304 down to user N 306, each with a respective mobile telephone 308, 310, 312 and each mobile telephone with its own unique identification number (e.g. the telephone number of the telephone). The e-purse sub-system 202 is run of from a mobile telephone payment gateway 320, which stores the e-purse database 204 on a server 322. The mobile telephone payment gateway 320 itself has a telephone number to make it accessible from the mobile telephones 308, 310, 312. Secure data links connect the mobile telephone payment gateway 320 to a number of banks 332, 334, each of which maintains its own bank database 104. Each bank database 104 is reflected in a separate e-purse database 204, as the total in each e-purse database 204 is a reflection of the amount in the consolidated c-purse bank account 120 held in an individual bank.

The mobile telephone payment gateway 320 is also connected to the Internet 340 through a link protected by a firewall 342. Preferably, all account details are available through a secure web site, accessible to users via authenticated login.

Communications between the users 302, 304, 306 and the mobile telephone payment gateway 320 is via Short Message Service (SMS) messages 352, 354, 356. The transmission of the SMS messages 352, 354, 356 may be by way of a number of known means. For example, there may be several GSM modems at the mobile telephone payment gateway 320 to send/receive such SMS messages. Alternatively, the mobile telephone payment gateway 320 can connect through a high speed data link to an SMS messaging centre of a mobile telephone service provider to send and receive SMS messages.

The users 302, 304, 306 can communicate with the mobile telephone payment gateway 320 to check the amount of funds in their respective e-purses by SMS messages or via the Internet.

FIG. 4 shows two banks 332, 334 within the transaction system 300. There may be more. Where there is more than one bank there will need to be a transfer of funds between banks. This is achieved through a transfer of actual money. Assuming the money is to be paid by a first user having his credit account with a first bank 332 and he is making payment to a second user having his credit account with the second bank 334, for the e-purse database 104 associated with the first bank 332, the funds are taken from the relevant user e-purse and encashed into the e-purse sub-system current account 124 via the e-purse sub-system credit account 122. The money is then transferred in a normal bank to bank transfer from the first bank 332 to the second bank 334. At the second bank the funds are put into the consolidated e-purse account 120, via the local e-purse sub-system credit account 122, where they are allocated to the e-purse for the second user.

### Transferring Funds—Customer Initiated Payment

The mobile payment account for each user 302, 304, 306 is identified with the user's mobile telephone number. To transfer funds from user 1 302 to user 2 304, for example, user 1 302 sends an SMS message 352 to the mobile telephone payment gateway 320 specifying the monetary amount, to be transferred: and at the same time identifying user 2 as the recipient. Users may be identified by telephone numbers, as exemplified below, or by unique user identification (ID) numbers.

### (i) Through Escrow

The preferred embodiment assumes that purchases are made remotely, for instance from advertisements over the Internet, in brochures or magazines or from posters. As a buyer may want to check that he does indeed receive the correct goods or service before the merchant is paid, it may be preferable in such cases that the transfer of funds from the buyer to the merchant is not immediate, but through the escrow e-purse 226 as described above.

Assuming user 2 304 advertises “Product A” for $30, and user 1 wants to buy this product. User 1 302 then sends an SMS message 352 to the mobile telephone payment gateway 320. An example of such an SMS message 352 is:

“BUY+60121112222 $30 Product A”,

where “+60121112222” is the telephone number associated with user 2 304 (user 2 does not need to be using a mobile telephone). Product A is indicated to identify the product to be sent.

When the mobile telephone payment gateway 320 receives this SMS message, it identifies and authenticates user 1 through the sender ID of the SMS message 352 (or by some other mechanism). Assuming user 1 is authenticated, $30 is transferred from the user 1 e-purse 212 to the escrow e-purse 226. The mobile telephone payment gateway 320 then informs user 2 304 of user 1's 302 intention to buy “product A”, for instance by an SMS message such as:

“+60123332222 requests Product A”,

or, alternatively, if the mobile telephone payment gateway 320 has user 1's particulars:

“Mr User 1 +60123332222 of 5 Trinity Street, CB2 1TQ requests Product A”, where “+60123332222” is the telephone number associated with user 1. User 2 304 can communicate with and/or locate user 1 302 through this number, i.e. +60123332222.

Optionally, the mobile telephone payment gateway 320 also sends an acknowledgement to user 1—, for instance by an SMS message such as:

“Please reply this message with ‘Received Product A’ to acknowledge receipt”.

When user 1 receives “Product A” from user 2, user 1 sends another SMS message to the mobile telephone payment gateway 320, for instance:

“Received Product A”.

When the mobile telephone payment gateway 320 receives this SMS message acknowledging receipt, funds held in the escrow e-purse 226 are transferred to the user 2 e-purse 214. Transaction charges may be levied as indicated in the description above.

If however user 1 302 funds the “Product A” he receives from user 2 is the wrong product, damaged, not what he was expecting or otherwise unacceptable, or if Product A does not arrive, user 1 may cancel the whole transaction by sending a different message to the mobile telephone payment gateway 320, for instance an SMS message such as:

“Cancel Product A”.

At this point, the funds held in the escrow e-purse 226 are returned to the user 1 e-purse 212. Alternatively, this may first require user 1 to return Product A to user 2 and for user 2 to acknowledge receipt of the returned Product A. Again, transaction charges and possibly other charges may apply, as described above.

Alternatively, in the above embodiment, user 2 may pre-register “Product A” with the mobile telephone payment gateway 320. In is case, user 1 needs only send an abbreviated form of message to the mobile telephone payment gateway 320 specifying “Product A”, without further need of identifying user 2 nor the need to specify the sales amount—, for example by sending:

“BUY Product A”.

### (ii) Directly

As is mentioned above, in some embodiments, there is no need to use escrow. This is especially so for direct purchases (rather than remote ones), or when someone is being given money. An example of an SMS message 352 that might be sent by user 1 302 to transfer money to user 2 304 in such an instance is:

“Transfer +60122070239 $50”

where “+60122070239” is the telephone number of the user 2 mobile telephone and “$50” is the amount to be transferred from user 1 to user 2. There is no need to identify the product, as the two parties would know already in a face to face sale (although it could be identified if desired).

The mobile telephone payment gateway 320 identifies and authenticates user 1 through the sender ID of the SMS message 352 (in other embodiments, a password or personal identification number [PIN] may also be required from the user). Assuming user 1 is identified and authenticated, the transfer process proceeds as described above with reference to FIG. 2.

Optionally, after the transfer has been completed the merchant 304 receives a message from the mobile telephone payment gateway 320 to indicate a successful transfer. The confirmatory message indicating a successful transfer is preferably also an SMS message, but may alternatively be a voice message or other form of messaging. Optionally, the confirmatory message indicating a successful transfer is also sent to the customer 302.

### Transferring Funds—Merchant Initiated Payment

In an alternative payment variation, a merchant (e.g. user 2 304) requests payment from a consumer (e.g. user 1 302) by sending an SMS message 354 to the mobile telephone payment gateway 320. The mobile telephone payment gateway 320 then transmits an SMS message 352 to the consumer 302, seeking authorisation to pay the merchant 304. The consumer 302 can consent to this payment by replying to this SMS message 352.

To illustrate this, a merchant 304 (with mobile number “+60123332222”) sends an SMS text message 354 to the mobile telephone payment gateway 320 to request payment of $30 from a consumer 302 (with mobile number “+601233311111”):

“REQUEST +60123331111 $30”

When the mobile telephone payment gateway 320 receives this SMS message 354, it verifies and authenticates that the message is from the merchant 304, based on the sender ID of the SMS message 354, which is “+60123332222”. After such verification, the mobile telephone payment gateway 320 sends an SMS text message 352 to the consumer 302 whose telephone number is +60123331111:

“Merchant +60123332222 request payment of $30, to consent to this payment, please reply YES.”

If the consumer replies “YES”, the mobile telephone payment gateway 320 identifies and authenticates user 1 302 through the sender ID of the SMS message 352 and the transfer is carried out as described above with reference to FIG. 2.

As relying on a mere “YES” response limits the number of outstanding confirmation requests that any single user may have, alternatively, the message from the mobile telephone payment gateway 320 to the consumer 302 includes a number to identity the particular transaction:

“Merchant +60123332222 request payment of $30—transaction ID 31312. To consent, please send this message back to us.”

In this case, when the mobile telephone payment gateway 320 receives a response message, it parses the message to look for the token “31312” which ties the acknowledgement from the consumer back to the original payment request.

This feature where the merchant can initiate a payment request is especially useful to prevent errors such as the consumer wrongly keying in an SMS text message, e.g. a wrong user 2 telephone number. For instance, in the case of a customer-initiated payment, it is not unlikely that a customer may enter a wrong recipient telephone or ID number for the fund transfer and the funds transferred may be lost. For example, an intended message

“Transfer +60122070239 $50”

may incorrectly be keyed in as

“Transfer +60122070229 $50”.

In a merchant initiated payment, the problem of lost funds would not arise, as the user of +60122070229 (as wrongfully keyed in by the merchant) would not consent to such payment.

### Transferring Funds—Withdrawal of Funds

A user, such as user 2 304 may wish to withdraw fends from the user 2 e-purse to the user 2 current account. He can achieve this by way of an SMS message 354 to the mobile telephone payment gateway 320 specifying the monetary amount to be transferred and the destination. An example of such an SMS message 354 is:

“Withdraw $50 to bank account”

where “$50” is the amount to be withdrawn and the destination being the user 2 bank account 108 associated with the user 2 credit account 114. If the user 2 304 wished to transfer the funds to the user 2 credit account 114, he would indicate “to credit account” instead. If the user 2 304 wished to transfer the funds to be withdrawn directly as cash to be received at a bank, he would indicate “to cash” instead.

When the mobile telephone payment gateway 320 receives a withdrawal SMS message from user 2, it verifies and authenticates that the message is from the user 2 304, based on the sender ID of the SMS message 354. After such verification, the withdrawal is carried out as described above with reference to FIG. 3.

When the basic user account from which funds are transferred to the e-purse sub-system 202 is a credit account, the mobile telephones of the users become, in effect, virtual credit cards. However, there are distinct advantages in this set up as compared with traditional credit cards. A user, such as a merchant, who is paid using this e-purse system can immediately utilise the payment he received for further purchases of his own, i.e. the credit, in effect “floats” in the system.

In the above-described embodiments, customers and merchants are treated in the same way, depending on the roles they play in the particular transactions rather than their status as merchants seeking to make a living. In traditional credit card transactions, merchants are charged a predetermined percentage of each transaction, which varies from 1% to 3%. Similarly, for the described mobile payment to be viable as a business, merchants are charged for their transactions. However in this system, funds can be transferred even among consumers and, if they are charged for such transactions, consumers may be put off adopting this mobile payment method. Thus it is useful to know who the merchants are so, that they can charged for their transactions (so that consumers are not charged or are charged at a reduced rate).

There are several mechanisms for determining which users are merchants, and in actual implementation, one or a combination of these mechanisms can be used, for example:

1. A distinguishing feature of merchants is that merchants usually make more transactions as compared to a normal consumer. Hence, transactions above a predetermined frequency and/or amount are charged a certain percentage of the transaction amount.

2. A service charge is levied one fund withdrawal from e-purses. This is due to the fact that consumers tend to buy goods or services whereas merchants tend to receive payment for their goods or services. Hence, merchants are charged for all payments they have received when they withdraw accumulated payments from their e-purses.

Additional mechanisms can be implemented for charging more for certain actions. These can be applied to identified merchants and possibly to non-merchant users. For example, when a user receives funds from a buyer, such funds must be kept inside the user's e-purse for a certain predetermined duration. If a user were to transfer such funds out to his credit or current account prior to the expiry of this term, the user is charged an additional “fee” for doing so. Preferably however, the user may freely transfer such funds to the e-purses of other users without further charge, such as to the user 2 e-purse. It is then up to the user to whom the funds are transferred to wait a further predetermined duration before he can cash out his e-purse. If desired, different durations can apply to merchant users and non-merchant users. The reasoning behind this non-waiting charge is that funds inside e-purses are held inside the consolidated account, in the name of the company running the mobile telephone payment gateway, and such funds generate interest for this company. If such funds have to left in the system for a minimum time, then certain interest accruals are guaranteed and the other transaction charges can be set lower as a result.

### Distribution Tree Tracking & Commission Payment

Where a user is a distributor, he can identify another user as his sub-distributor to the e-purse system 100, for the distribution of payments between them. This maybe achieved by the distributor sending an SMS message to the mobile telephone payment gateway 320. For example, if user 2 304 is to identify user N 306 as his sub-distributor, he sends an SMS text message 354 to the mobile telephone payment gateway 320:

“SUB01 +60122223333 05%”

where “SUB” is a predetermined SMS keyword for this purpose, 01 is a keyword identifying to which of the distribution trees for user 2 this entry belongs, “+60122223333” is the mobile telephone number for the user N mobile telephone 312 and 05% is the percentage of any payment attributed to this tree that is to be passed to user N. There may be several entries in a single distribution tree, so each member receives a percentage when user 2 indicates that a received payment should be distributed according to a particular tree.

In this manner, a number of distribution tree structures corresponding to different distribution chains can be built and kept in the e-purse database 104 with minimal intervention and data entry overhead for operators of the e-purse system 100.

Alternatively, different SMS keywords are also used to identity different hierarchy levels within a single distribution tree. For example “SUB1” may used to identify top level distributors, “SUB2” to identify second level distributors, and so on.

Having built the distribution tree structures in the e-purse database 104, the commission due to each level of distributors can easily be calculated and paid in real time the moment a sale is completed and the whole process can be totally paperless. For tracking the sales of different products, merchants can register different SMS keyword for different products, allowing them to determine the correct distribution tree to use. Thus by using different SMS keywords, sales for different products can be captured and accounted for in the e-purse system 100. If necessary, commission can be paid for these sales to the merchants within the distribution free hierarchy.

There can be several distribution trees possibly with overlapping membership. Different commission scheme can be used for different distribution trees. Different commissions can be paid for different products. Commission calculations can be done in real time the moment the funds are transferred from consumer to merchant. Commissions paid can be viewed from the mobile payment web site.

### Subscription Management

By registering their products and customers with the mobile telephone payment gateway 320, e.g. through an SMS message or the web site, a merchant can let the mobile telephone payment gateway 320 manage payments from customers.

For example, whereas currently a newspaper seller needs to go door to door to collect payment every month, this can be avoided with the present system. If he registers his customers with the mobile telephone payment gateway 320, the mobile telephone payment gateway 320 can transmit a payment request to the customers monthly to request payment. All these transactions can be viewed and managed through the mobile payment web site.

Alternatively, if a customer agrees to it, the mobile telephone payment gateway 320 can pay the merchants automatically without first explicitly requesting payment from the customer. The same might apply to collecting payments periodically from consumers who are subscribers of other registered products: e.g. magazines for example, or even payment of utility bills or rent.

### Tokens

The e-purse system 100 can also be used beyond a simple transfer from one user e-purse to another based on a specific purchase. The system can also be used to issue tokens, which are particularly useful for making purchases through automated systems.

When a user wishes to obtain a token, he sends an SMS message requesting the issue of a token for a specific amount. The specific amount is taken from the relevant user e-purse and transferred to the escrow e-purse 226. An SMS message is also sent back to the user including the token in the form of a random (or apparently random) numeric or alphanumeric string. Checks are made as to where the user 1 e-purse 212 has sufficient funds and new funds are requested if necessary, as described above.

As long as the token has not expired, been cancelled or used, the user is able to use it to make payments without specific use of the mobile telephone. For instance, if the user is making a payment for petrol he enters the token (e.g. types in the numeric string) on a keypad on a petrol pump. The petrol pump control automatically contacts the mobile telephone payment gateway 320 to determine if the token is valid and how much it represents. If the token is valid, the pump dispenses fuel up to the value of the token. The pump then contacts the mobile telephone payment gateway 320 to specify the actual amount of the purchase. That amount (or that amount less the transaction charges) is transferred from the escrow e-purse 226 to the e-purse of the garage operating the pump. The remainder is transferred back to the user. A token can only be used one time, although a newly bought token could be the same numeric or alphanumeric string as a previously used token.

If the token has a use by date and is not used by that date, it is automatically cancelled and the funds returned from the escrow e-purse 226 to the user's e-purse. The same happens if the token is deliberately cancelled by the user. In both cases, a service charge may first be removed from the funds in the escrow e-purse 226 and transferred to the transaction charges e-purse 228.

A similar approach could be used for withdrawing cash from an automated teller machine ATM.

A user may have several such tokens on his mobile telephone at any one time. However, he does not need to keep the tokens on his telephone; he could write them down or put them on to some other electronic device.

One potential disadvantage of such tokens is that they would be freely available to anyone who has access to the mobile telephone. As such, access to them within the telephone can be protected by way of a password or PIN. Another possibility is to bury such tokens amongst other data, for instance to hide a token amongst the telephone numbers in a contact list. In one embodiment, the user provides the mobile telephone payment gateway 320 with one or more dummy contact names, for instance when signing up for the e-purse system, or at a later point. When a token is requested by the user, the token is generated by the c-purse sub-system, added to the pre-agreed dummy contact name or one of the pre-agreed dummy contact names and forwarded to the user's telephone, as if it were a name card forwarded to the user like a contact from any other mobile telephone. The user then saves the contact into his contacts list. Provided the token looks like a telephone number, it is then indistinguishable from other numbers in the contact list, unless someone tries going through all the numbers to fund out which are real and which are dummy telephone numbers.

The token does not have to be the whole of the dummy telephone number for the dummy contact or just the dummy telephone number for the dummy contact. The token could, for instance be all but the first two digits of the number or the last two, or some other limited number of them. The token could be some or all of the dummy telephone number plus some letters taken from the names of the dummy contact. The token could be some or all of the dummy telephone number plus a password or PIN agreed with the user but not in the contact details. The token could be a combination of information from two or more different dummy contacts in the contact list. There are many ways of providing such tokens.

Moreover, the token does not necessarily need to be in the telephone number. The token could be in the contact name or other aspects of the contact details, where the telephone number is the information previously agreed with the mobile telephone payment gateway 320.

The tokens do not necessarily need to be of monetary value. They could be used to purchase a predetermined product or service, e.g. 10 gallons of petrol from a specific chain of petrol stations (this way they could be sold to users for a slight discount of the pump price).

The provision of such confidential information by sending it within contact details is not limited to tokens or to use within an e-purse system. Other confidential information such as passwords or PINs issued by banks for telephone or Internet banking or ATM access can be sent in a similar fashion.

### Distribution of Information-Based Products

The e-purse system 100 can additionally be used for the distribution of information-based products such as ring tones, PINs for reloading prepaid mobile telephone accounts, mobile telephone wallpapers, mobile telephone Java games etc. When a user sends in a predetermined SMS message requesting such a product, the mobile telephone payment gateway 320 transmits the requested information to the user, at the same time deducting an appropriate payment from the user's e-purse.

### Other

The e-purse system 100 does not necessarily need to be used to make purchases; it can be used non-sale transactions. For example, it also allows people-people fund transfers, such as a parent transferring an allowance to a child, or is a useful method of making charitable donations.

In yet another embodiment, the transactions are activated by multimedia messaging service (MMS) messages, Enhanced Messaging Service (EMS) messages or other messages sent and received via mobile telephony. Payment can even be initiated throughout a voice call to a computer operated menu system. In other embodiments, the relevant messages do not need to be sent and received by mobile devices. For instance they can be sent from and received on fixed devices, such as a land-line telephone or computer or can be sent and received over the Internet.

Mobile telephones are particularly advantageous for using with various aspects of the present invention (certainly compared with email, smartcard or other means), because they are communication devices and also inherent authentication devices in one. Through this combination, a user can authenticate and communicate almost anywhere without restriction. This contrasts with other means we have the restriction of one without the other, at least not without extra inconvenience for the user. For example, a user may have an authentication device, such as a smartcard, but he cannot communicate the transaction he requires because there is no integral communications channel. Likewise, with a simple email, there is clearly a communications channel, but no authentication. If an aspect is limited to no transaction being possible without “authentication” and “communication” being done at the same time, then a mobile telephone is ideally placed for use with such aspects.

In the above-described embodiments, although a distinction is made between a merchant and a customer for the purpose of clarity, it is understood that a merchant can also be a customer and vice versa. In this way, credit can be transferred seamlessly from one user to another without restrictions. Although only several embodiments are described, it should be understood that the embodiments described herein are but embodiments of underlying concepts of the invention. Alternatives to the embodiments, though not described, are intended to be Within the scope of this invention as claimed, for example, methods of identification and security features as are known in the art.

1-75. (canceled)

76. A method of making transactions between e-purses, wherein the e-purses represent funds belonging to different users, with the total of the funds represented by the e-purses being mirrored in a consolidated bank account in a bank, the method comprising:
instructing a transaction comprising a transfer of funds from a first e-purse to a second e-purse by an electronic message;
removing funds from the first e-purse as a result of the electronic message; and
transferring funds into at least the second e-purse as a result of the electronic message.

77. A method according to claim 76, further comprising holding funds removed from the first e-purse in escrow prior to transferring the funds into at least the second e-purse until the transfer into at least the second e-purse is approved.

78. A method according to claim 76, wherein once the funds are transferred into the at least the second e-purse, they are available immediately for use by the one or more users of the at least the second e-purse.

79. A method according to claim 76, wherein the transfer of funds from the first e-purse to at least the second e-purse occurs without requiring a transfer of funds between bank accounts associated with a first user of the different users and a second user of the different users and occurs without being reflected in the consolidated bank account.

80. A method according to claim 79, further comprising determining if the first e-purse contains sufficient funds for the instructed transfer and requesting a transfer of sufficient additional funds into the consolidated bank account on behalf of the first user when the first e-purse is determined to contain insufficient funds for the instructed transfer; the bank, in response to the request, transferring the sufficient additional funds into the consolidated bank account, on behalf of the first user, from a bank account belonging to the first user.

81. A method according to claim 80, further comprising the bank determining if the bank account belonging to the first user contains the sufficient additional funds or a sufficient allowance of funds and only transferring the sufficient additional funds when the bank account belonging to the first user is so determined to contain the sufficient additional funds or a sufficient allowance of funds.

82. A method according to claim 80, further comprising determining if the sufficient additional funds are transferred into the consolidated bank account on behalf of the first user and not removing the funds from the first e-purse until the sufficient additional funds are transferred into the consolidated bank account on behalf of the first user.

83. A method according to claim 76, wherein the amount of funds removed from the first e-purse is a first amount of funds and the amount of funds transferred into the at least a second e-purse is a second amount of funds which is less than the first amount of funds, said second amount of funds being transferred into only one second e-purse.

84. A method according to claim 76, wherein transferring funds into at least a second e-purse comprises transferring funds into a second e-purse and at least a third e-purse, according to a predetermined distribution tree; transferring funds into the second e-purse and at least the third e-purse occurring automatically, based on the content of the electronic message.

85. A method according to claim 84, wherein transferring funds into the second e-purse and at least the third e-purse occurs based on the content of a further electronic message from the user of the second e-purse.

86. A method according to claim 84, wherein the ratio of funds transferred funds into the second e-purse and at least the third e-purse is predetermined and associated with the predetermined distribution tree.

87. A method of obtaining tokens of a monetary value or for making a specific purchase, comprising:
instructing a transaction comprising a request, by an electronic message, for a token, the token being of a monetary value or for making a specific purchase;
removing funds from a first e-purse as a result of the electronic message; and
transmitting the token electronically to a first user with whom the first e-purse is associated.

88. A method according to claim 87, wherein the first e-purse is in an e-purse database comprising a plurality of e-purses represent funds belonging to different users, with the total of the funds represented by the e-purses being mirrored in a consolidated bank account in a bank.

89. A method according to claim 88, further comprising:
determining if the first e-purse contains sufficient funds for the requested token and
requesting a transfer of sufficient additional funds into the consolidated bank account on behalf of the first user when the first e-purse is determined to contain insufficient funds for the requested token.

90. A method according to claim 89, wherein the token is transmitted to be hidden as a telephone number amongst contact details on an electronic receiving device of the first user.

91. A method according to claim 89, further comprising:
the first user providing the token to a second user by inputting the string via a keypad; and
transferring funds removed from the first e-purse into at least a second e-purse, associated with at least a second user.

92. A method according to claim 91, wherein removal of funds from the first e-purse and the transfer of funds into the second e-purse occurs without requiring a transfer of funds between bank accounts associated with the first and second users and occurs without being reflected in the consolidated bank account.

93. A method according to claim 91, further comprising holding funds removed from the first e-purse in escrow prior to transferring the funds into the second e-purse until the transfer into the second e-purse is approved.

94. A method of withdrawing funds from a first e-purse from an e-purse database comprising a plurality of e-purses represent funds belonging to different users, with the total of the funds represented by the e-purses being mirrored in a consolidated bank account in a bank, the method comprising:
instructing a transaction comprising a withdrawal of funds from the first e-purse by an electronic message;
removing funds from the first e-purse as a result of the electronic message; and
removing funds from the consolidated bank account into a bank account associated with the user of the first e-purse as a result of the electronic message; wherein
the amount of funds removed from the consolidated bank account is deleted from the funds in the e-purse database.

95. A method according to claim 94, wherein the amount of funds removed from the first e-purse is a first amount of funds and the amount of funds removed from the consolidated bank account is a second amount of funds which is less than the first amount of funds.

96. A method according to claim 94, further comprising transferring a third amount of funds to a third e-purse, the third amount of funds representing at least one of a commission and transaction charges, and wherein the first amount of funds is equal to the sum of the second and third amounts of funds.

97. A method according to claim 94, further comprising determining if the electronic message is accompanied by authenticating information associated with the first e-purse and not proceeding with the step of removing funds from the first e-purse if the electronic message is determined not to be accompanied by the authenticating information associated with the first e-purse; the determining if the electronic message is accompanied by authenticating information comprising making a determination based on authenticating information inherently sent with the electronic message.

98. A method of transmitting confidential information to a predetermined user, comprising:
associating the confidential information with other contact details agreed with the predetermined user to generate a dummy contact; and
sending the dummy contact to an electronic device associated with the user.

99. A method according to claim 98, further comprising the user receiving the sent dummy contact and saving the received dummy contact into a contacts list.

100. A method according to claim 98, wherein the dummy contact is at least one selected from the group consisting of: a name and a telephone number, in a format that is the same as other contacts in a contact list in the electronic device associated with the user, and indistinguishable from non-dummy contacts merely from viewing the dummy contact.

101. A method according to claim 98, wherein the confidential information is generated by a body controlling the money or money's worth and comprises at least one selected from the group consisting of: information for obtaining access to money, information for gaining access to money's worth, information for accessing information on a bank account, information for accessing funds in a bank account, a token for inputting into a machine for paying for goods or services, a token for inputting into a machine for paying for goods or services up to a predetermined amount, a password, and a PIN.

102. An e-purse system for receiving transaction instructions sent by an electronic message, to transfer funds between users of the system, comprising:
an e-purse database comprising a plurality of e-purses represent funds belonging to different users;
a bank database comprising a consolidated bank account; wherein
the transfer of funds between users of the system comprise transfers of funds between e-purses; and
the totals of funds represented by the e-purses are mirrored in the consolidated bank account.

103. A system according to claim 102, further comprising a payment gateway for receiving transaction instructions as electronic messages; an e-purse sub-system for acting on received transaction instructions using a telephone message; and a plurality of bank accounts, individual bank accounts associated with different users, wherein the transfer of funds between e-purses occurs without requiring a transfer of funds between the bank accounts associated with the first and second users.

104. A system according to claim 102, wherein the transfer of funds between e-purses occurs without being reflected in the consolidated bank account; and the e-purse database further comprises an escrow e-purse for holding funds between removal from one e-purse and transferral into another e-purse.

105. A system according to claim 102, operable, in response to instructions for a transaction comprising a transfer of funds from a first e-purse to a second e-purse, to:
remove funds from the first e-purse as a result of the instruction; and transfer funds into the second e-purse as a result of the instruction.

106. A system according to claim 102, operable, in response to transaction instructions to issue a token, to:
remove funds from a first e-purse as a result of the transaction instructions; and
transmit the token electronically to a first user with whom the first e-purse is associated.

107. A system according to claim 106, further comprising token input means for the first user to input a token thereby and operable, in response to the first user inputting the token by the token input means, to transfer funds from the first e-purse into a second e-purse associated with the token input means; the token input means comprising a keypad.

108. A system according to claim 102, operable, in response to instructions for a transaction comprising a withdrawal of funds from a first e-purse, to:
remove funds from the first e-purse as a result of the instructions; and
removing funds from the consolidated bank account into a bank account associated with the user of the first e-purse as a result of the instructions; wherein
delete the amount of funds removed from the consolidated bank account from the funds in the e-purse database.
